(19) United States
(12) Patent Application Publication
(10) Pub. No.: US 2024/0079694 A1
(43) Pub. Date: Mar. 7, 2024

(54) CELL STACK END CAPS FOR USE WITHIN TRACTION BATTERY PACKS

(71) Applicant: FORD GLOBAL TECHNOLOGIES, LLC, Dearborn, MI (US)

(72) Inventors: Deanna Marie Winton Hoffman, Ann Arbor, MI (US); Brock Dunlap, Dearborn, MI (US); Michael E. Reibling, Sterling Heights, MI (US)

(21) Appl. No.: 18/176,746

(22) Filed: Mar. 1, 2023

Related U.S. Application Data
(60) Provisional application No. 63/403,445, filed on Sep. 2, 2022.

(51) Int. Cl. H01M 50/159; H01M 50/148

(52) U.S. Cl. CPC H01M 50/159; H01M 50/148; H01M 2220/20

(57) ABSTRACT

Cell stack end caps are provided for use within traction battery packs. An end cap may be positioned to at least partially fill a volume of space between a cell stack and an enclosure structure (e.g., an enclosure tray) inside the traction battery pack. The end cap may be configured to square a draft angle of a side wall of the enclosure structure in order to impart a compressive load to the cell stack and/or the enclosure structure. A foam structure may be positioned between the end cap and the enclosure structure or within a hollow passageway of the end cap for increasing the structural integrity of the traction battery pack.

### CROSS-REFERENCE TO RELATED APPLICATIONS

This disclosure claims priority to U.S. Provisional Application No. 63/403,445, which was filed on Sep. 2, 2022 and is incorporated herein by reference.

### TECHNICAL FIELD

This disclosure relates generally to traction battery packs, and more particularly to end caps for establishing an interface between cell stacks and an enclosure structure inside a traction battery pack.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, an enclosure assembly, a cell stack housed within the enclosure assembly, and an end cap arranged to establish an interface between a side wall of the enclosure assembly and the cell stack.

In a further non-limiting embodiment of the foregoing traction battery pack, the cell stack includes a grouping of battery cells supported between a first cross-member beam and a second cross-member beam.

In a further non-limiting embodiment of either of the foregoing traction battery packs, the end cap is attached to a pultrusion insert of the first cross-member beam or the second cross-member beam.

In a further non-limiting embodiment of any of the foregoing traction battery packs, the side wall includes a draft angle, and the end cap squares the draft angle.

In a further non-limiting embodiment of any of the foregoing traction battery packs, the end cap includes a first side section that interfaces with the cell stack and a second side section that interfaces with the side wall.

In a further non-limiting embodiment of any of the foregoing traction battery packs, a foam structure is arranged between the second side section and the side wall.

In a further non-limiting embodiment of any of the foregoing traction battery packs, the first side section is flat and the second side section is sloped or angled to match a draft angle of the side wall.

In a further non-limiting embodiment of any of the foregoing traction battery packs, the end cap includes an upper section that interfaces with an upper enclosure structure and a lower section that interfaces with a lower enclosure structure.

In a further non-limiting embodiment of any of the foregoing traction battery packs, an adhesive is disposed between the first side section and the cell stack and further between the second side section and the side wall.

In a further non-limiting embodiment of any of the foregoing traction battery packs, the end cap includes a first side section, a second side section, an upper section, and a lower section arranged to substantially circumscribe a hollow opening of the end cap.

In a further non-limiting embodiment of any of the foregoing traction battery packs, a gap extends between the lower section and the second side section.

In a further non-limiting embodiment of any of the foregoing traction battery packs, the end cap includes a continuous, non-interrupted perimeter.

In a further non-limiting embodiment of any of the foregoing traction battery packs, the end cap includes a first end cap section and a second end cap section that nests together with the first end cap section.

In a further non-limiting embodiment of any of the foregoing traction battery packs, the first end cap section includes a first flange section and the second end cap section includes a second flange section. The second flange section overlaps the first flange section to establish a nesting interface between the first end cap section and the second end cap section.

In a further non-limiting embodiment of any of the foregoing traction battery packs, a foam structure urges the second end cap section into the first end cap section.

A traction battery pack according to another exemplary aspect of the present disclosure includes, among other things, an enclosure assembly including an enclosure cover and an enclosure tray, a cell stack received within the enclosure tray and including a grouping of battery cells arranged between a first cross-member beam and a second cross-member beam, and an end cap arranged between the cell stack and a side wall of the enclosure tray and configured to exert a compressive load against at least one of the cell stack or the side wall.

In a further non-limiting embodiment of the foregoing traction battery pack, the end cap includes a side section configured to square a draft angle of the side wall.

In a further non-limiting embodiment of either of the foregoing traction battery packs, the end cap is a unitary, single-piece metallic structure.

In a further non-limiting embodiment of any of the foregoing traction battery packs, the end cap is a multi-piece metallic assembly that includes a first end cap section and a second end cap section that is configured to nest together with the first end cap section.

In a further non-limiting embodiment of any of the foregoing traction battery packs, a foam structure is arranged between the end cap and the side wall or arranged within a hollow opening of the end cap.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 illustrates an exemplary cross-member assembly for a traction battery pack.

FIG. 4 illustrates an exemplary end cap of a cell stack of a traction battery pack.

FIG. 5 illustrates a position of the end cap of FIG. 4 between the cell stack and an enclosure structure of a traction battery pack.

FIG. 6 illustrates an exemplary cell stack equipped with a pair of end caps.

FIG. 7 illustrates another exemplary end cap for use within a traction battery pack.

FIGS. 8 and 9 schematically illustrate positioning the end cap of FIG. 7 between a cell stack and an enclosure structure of a traction battery pack.

FIG. 10 illustrates a position of an end cap between a cell stack and an enclosure structure of a traction battery pack.

FIG. 11 illustrates another exemplary end cap for use within a traction battery pack.

### DETAILED DESCRIPTION

This disclosure details cell stack end caps for use within traction battery packs. An end cap may be positioned to at least partially fill a volume of space between a cell stack and an enclosure structure (e.g., an enclosure tray) inside the traction battery pack. The end cap may be configured to square a draft angle of a side wall of the enclosure structure in order to impart a compressive load to the cell stack and/or the enclosure structure. A foam structure may be positioned between the end cap and the enclosure structure or within a hollow passageway of the end cap for increasing the structural integrity of the traction battery pack. These and other features are discussed in greater detail in the following paragraphs of this detailed description.

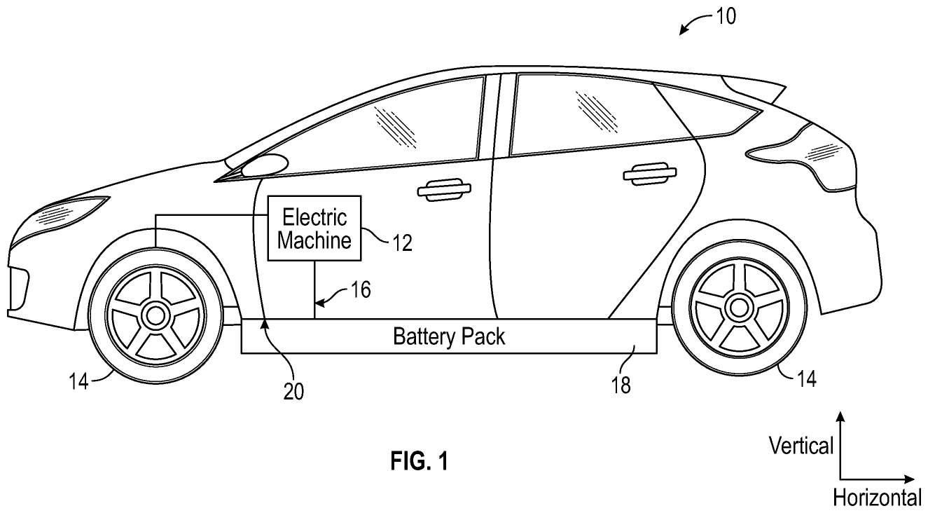

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

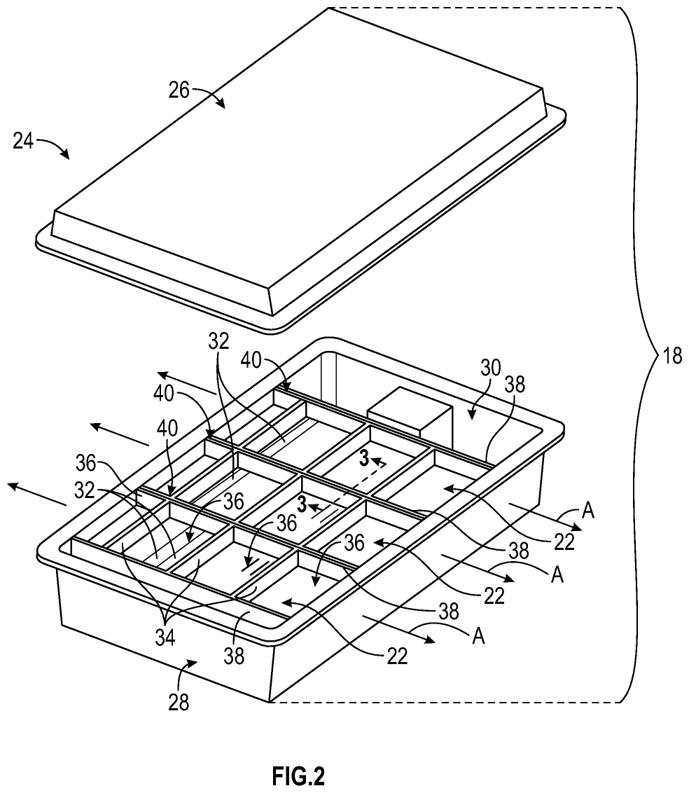

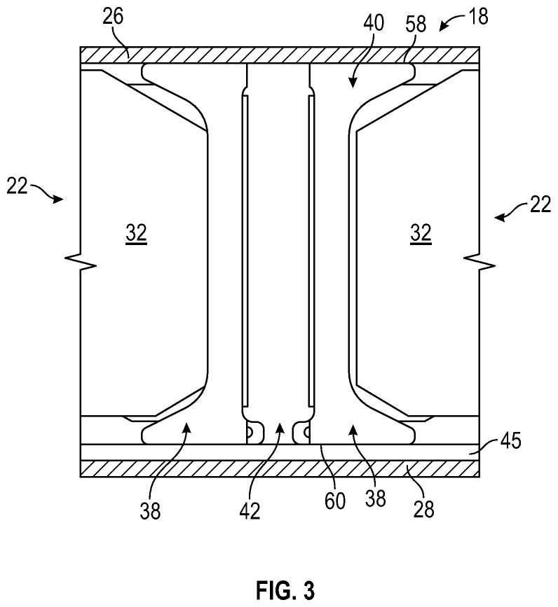

FIGS. 2 and 3 illustrate additional details associated with the traction battery pack 18 of the electrified vehicle 10. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cells stacks 22 and other battery internal components.

Each cell stack 22 may include a plurality of battery cells 32. The battery cells 32 of each cell stack 22 may be stacked side-by-side relative to one another along a cell stack axis A. The battery cells 32 store and supply electrical power for powering various components of the electrified vehicle 10. Although a specific number of cell stacks 22 and battery cells 32 are illustrated in the various figures of this disclosure, the traction battery pack 18 could include any number of the cell stacks 22, with each cell stack 22 having any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The exemplary battery cells 32 can include tab terminals extending from a battery cell housing. An aluminum film may provide the battery cell housing, for example.

The battery cells 32 of each cell stack 22 may be arranged between a pair of cross-member beams 38. The cross-member beams 38 may be configured to support the battery cells 32 and at least partially delineate the cell stacks 22.

Immediately adjacent-cross member beams 38 may establish a cross-member assembly 40 disposed between adjacent cell stacks 22 of the traction battery pack 18. The cross-member assemblies 40 may be configured to transfer a load applied to a side of the electrified vehicle 10, for example. Each cross-member beam 38 of the cross-member assemblies 40 may be a structural beam that can help accommodate tension loads from battery cell 32 expansion and compression loads. The cross-member assemblies 40 are therefore configured to increase the structural integrity of the traction battery pack 18.

The cross-member assemblies 40 may also establish a battery pack venting system for communicating battery cell vent byproducts from the traction battery pack 18 during battery thermal events. For example, the cross-member assemblies 40 may establish passageways 42 (best shown in FIG. 3) that can communicate battery cell vent byproducts from the cell stacks 22 toward a position where the battery cell vent byproducts can be expelled from the traction battery pack 18.

In the exemplary embodiment, first and second adjacent cross-member beams 38 may establish a first side and a second side, respectively, of the passageway 42 of the cross-member assembly 40. Further, a vertically upper side of the passageway 42 may be established by the enclosure cover 26 (see FIG. 3), and a vertically lower side of the passageway 42 may be established by a heat exchanger plate 45 positioned against the enclosure tray 28 (see FIG. 3). In another embodiment, the heat exchanger plate 45 may be omitted and the vertically lower side of the passageway 42 may be established by the enclosure tray 28. In still other embodiments, a heat exchanger plate may be mounted between the cell stacks 22 and the enclosure cover 26 and may establish the vertically upper side of the passageway 42. Vertical and horizontal, for purposes of this disclosure, are with reference to ground and a general orientation of traction battery pack 18 when installed within the electrified vehicle 10 of FIG. 1.

Each cross-member beam 38 may include one or more openings (not shown) for communicating the battery cell vent byproducts through the beams and into the passageway 42. The openings may thus provide a vent path for battery cell vent byproducts to move to the passageways 42 as required. Each cross-member beam 38 may additionally include one or more openings (not shown) for accommodating cell tabs of the battery cells 32.

The cross-member beams 38 may be adhesively secured to the enclosure cover 26 (or to an intermediate structure coupled to the enclosure cover 26) and to the heat exchanger plate 45 and/or enclosure tray 28. The adhesive can seal these interfaces to inhibit battery cell vent byproducts escaping the passageway 42 through these areas.

In an embodiment, the cells stacks 22, the cross-member assemblies 40, and the respective passageways 42 extend longitudinally in a cross-vehicle direction in a vehicle mounted position of the traction battery pack 18. However, other configurations and orientations are further contemplated within the scope of this disclosure.

One or more thermal barrier assemblies 34 may be arranged along the respective cell stack axis A of each cell stack 22. The thermal barrier assemblies 34 may divide or compartmentalize each cell stack 22 into two or more groupings or compartments 36 of battery cells 32. Should, for example, a battery thermal event occur in one of the cell stacks 22, the thermal barrier assemblies 34 may block or even prevent thermal energy associated with the thermal event from moving from cell-to-cell, compartment-to-compartment, and/or cell stack-to-cell stack, thereby inhibiting thermal propagation inside the traction battery pack 18.

Each compartment 36 may hold one or more of the battery cells 32 of one of the cell stacks 22. In an embodiment, the battery cells 32 of each cell stack 22 are held within one of four compartments 36. However, other configurations, including configurations that utilize a greater or fewer number of thermal barrier assemblies 34 and compartments 36, could be used within the scope of this disclosure.

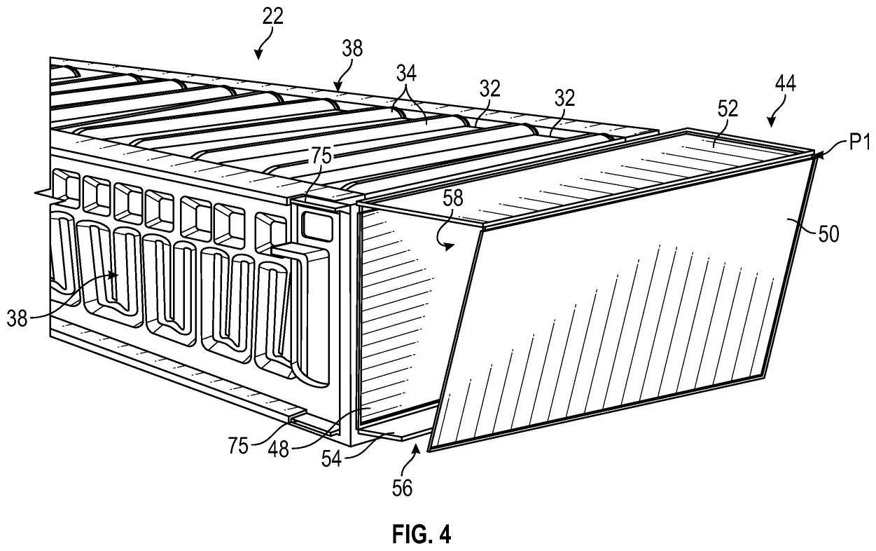

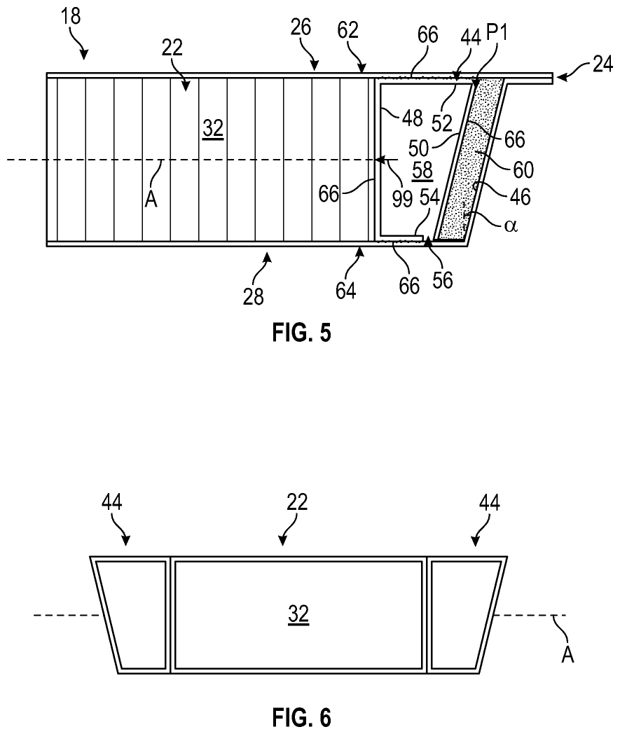

Referring now to FIGS. 4 and 5 (with continued reference to FIGS. 2-3), an end cap 44 may be positioned to fill a space between one or more of the cell stacks 22 and a side wall 46 of the enclosure assembly 24. The side wall 46 may be part of the enclosure tray 28, the enclosure cover 26, or both.

In an embodiment, the end cap 44 is located at a longitudinal extent of the cell stack 22. In other implementations, one end cap 44 could be provided at each opposing end of the cell stack 22 along the cell stack axis A (see FIG. 6). The end cap 44 may be positioned relative to the cell stack 22 either before or after positioning the cell stack 22 within the interior area 30 of the enclosure assembly 24. Once positioned, the end cap 44 fills a portion of the space encompassed by the interior area 30.

The end cap 44 may be made of a sheet of metallic material, such as steel, for example. The end cap 44 may further be a stamped or a cast component. However, other materials and/or manufacturing techniques could be utilized to construct the end cap 44 within the scope of this disclosure.

The side wall 46 of the enclosure assembly 24 may include a draft angle α (see FIG. 5) and therefore may not exhibit a profile that neatly accommodates the sum of the cell stack 22. The end cap 44 may therefore establish an interface that translates or “squares” the draft angle α of the side wall 46. Once positioned between the side wall 46 and the cell stack 22, the end cap 44 may exert a compression load 99 on the cell stack 22. The compression load 99 may be applied in a direction that is substantially normal (e.g., perpendicular) to the cell stack 22. The compression load 99 may counteract battery cell 32 expansion forces, for example.

The end cap 44 may be a unitary, single-piece structure that includes a first side section 48, a second side section 50, an upper section 52, and a lower section 54. The first side section 48, the second side section 50, the upper section 52, and the lower section 54 may be arranged to substantially circumscribe a hollow opening 58 of the end cap 44.

The upper section 52 of the end cap 44 may connect between the first side section 48 and the second side section 50. The lower section 54 of the end cap 44 may extend from the first side section 48 toward the second side section 50 but terminates prior to touching the second side section 50 such that a gap 56 extends between the lower section 54 and the second side section 50. The end cap 44 may therefore include an interrupted, non-continuous perimeter P1.

At least in part due to the presence of the gap 56, portions of the end cap 44 may deflect in response to battery cell 32 expansion forces occurring along the cell stack axis A. The end cap 44 may therefore function as a spring member for filling the space between the cell stack 22 and the side wall 46.

The first side section 48 of the end cap 44 may include a first profile, and the second side section 50 of the end cap 44 may include a second, different profile. The first profile of the first side section 48 may be configured to match the profile of the end of the cell stack 22, and the second profile of the second side section 50 may be configured to at least partially match the profile of the draft angle α of the side wall 46. Accordingly, in the exemplary embodiment, the first side section 48 includes a substantially flat profile, and the second side section 50 includes a sloped or angled profile. However, other configurations are contemplated within the scope of this disclosure.

A foam structure 60 (see FIG. 5) may be positioned between the end cap 44 and the side wall 46. The foam structure 60 may be configured to increase the structural integrity of the traction battery pack 18.

The first side section 48 of the end cap 44 may be configured to interface with the cell stack 22, the second side section 50 may be configured to interface with the side wall 46 (or the foam structure 60), the upper section 52 may be configured to interface with an upper enclosure structure 62 of the traction battery pack 18, and the lower section 54 may be configured to interface with a lower enclosure structure 64 of the traction battery pack 18. In an embodiment, the upper enclosure structure 62 is part of the enclosure cover 26 of the enclosure assembly 24, and the lower enclosure structure 64 is part of the enclosure tray 28 of the enclosure assembly 24. However, in other implementations, the upper section 52 and/or the lower section 54 of the end cap 44 may interface directly with an intermediate structure (e.g., a heat exchanger plate) that is positioned between the end cap 44 and the enclosure cover 26 and/or between the end cap 44 and the enclosure tray 28.

An adhesive 66 may be utilized to secure the end cap 44 in place relative to one or more surrounding structures of the traction battery pack 18. The adhesive 66 may be an epoxy based adhesive, a urethane based adhesive, two-sided adhesive tape, etc. The adhesive 66 may be applied between the cell stack 22 and the first side section 48 of the end cap 44, between the second side section 50 of the end cap 44 and the side wall 46 or the foam structure 60, between the upper section 52 of the end cap 44 and the upper enclosure structure 62, and/or between the lower section 54 of the end cap 44 and the lower enclosure structure 64. Once cured, the adhesive 66 can retain the end cap 44 in place and add stiffness across the traction battery pack 18.

In some implementations, the end cap 44 may be fixedly secured to the cross-member beams 38 of the cell stack 22. For example, the end cap 44 could be attached to pultrusion inserts 75 (see FIG. 4) of the cross-member beams 38. The term “pultrusion” implicates structure to these beam-like sections. A person of ordinary skill in the art having the benefit of this disclosure would understand how to structurally distinguish a pultruded beam structure from another type of structure, such as an extruded beam, for example.

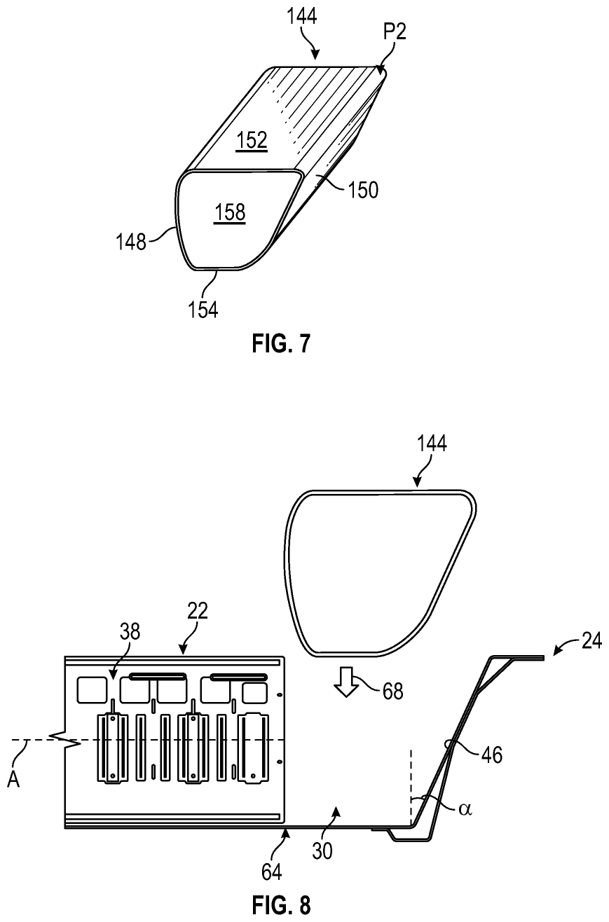

FIGS. 7-10 illustrate another exemplary end cap 144 that can be implemented for use within a traction battery pack, such as the traction battery pack 18 of FIGS. 1-3. Like the end cap design of FIGS. 4-5, the end cap 144 may be positioned to fill a space between one or more of the cell stacks 22 and a side wall 46 of the enclosure assembly 24. The side wall 46 may be part of the enclosure tray 28, the enclosure cover 26, or both.

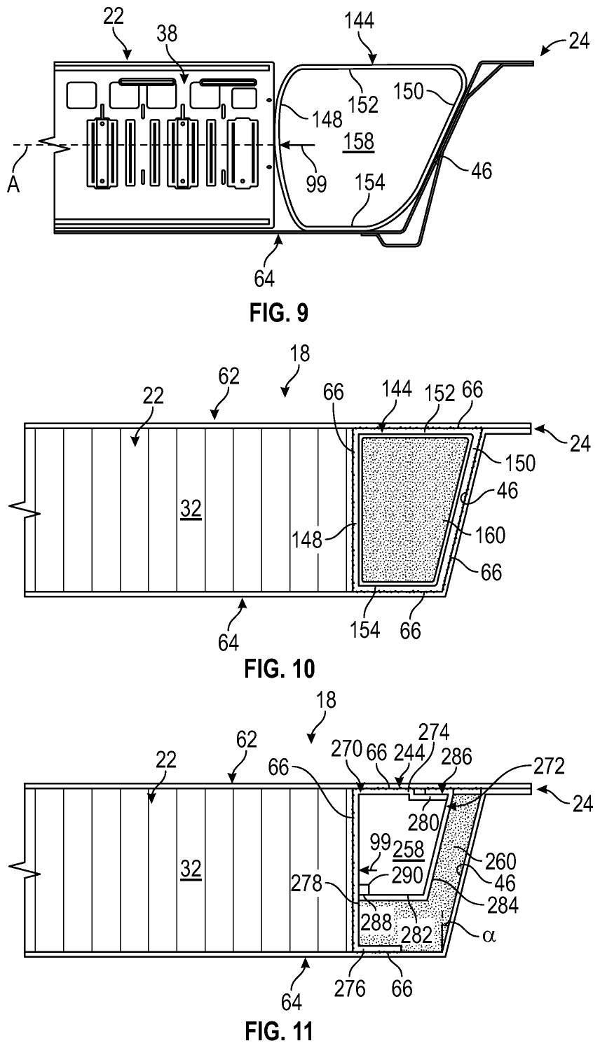

The end cap 144 may be positioned relative to the cell stack 22 after positioning the cell stack 22 within the interior area 30 of the enclosure assembly 24. For example, the end cap 144 may be moved in a direction 68 (see FIG. 8) toward the lower enclosure structure 64 until the end cap 144 is received against the lower enclosure structure 64. Once positioned, the end cap 144 fills a portion of the space encompassed by the interior area 30 (see FIG. 9).

The end cap 144 may be made of a metallic material, such as steel, for example. The end cap 144 may further be a stamped or rolled component. However, other materials and/or manufacturing techniques could be utilized to construct the end cap 144 within the scope of this disclosure.

The side wall 46 of the enclosure assembly 24 may include a draft angle α (see FIG. 8) and therefore may not exhibit a profile that neatly accommodates the sum of the cell stack 22. The end cap 144 may therefore establish an interface that translates or “squares” the draft angle α of the side wall 46. Once positioned between the side wall 46 and the cell stack 22, the end cap 144 may exert a compression load 99 on the cell stack 22 for counteracting battery cell 32 expansion forces, for example.

The end cap 144 may be a unitary, single-piece structure that includes a first side section 148, a second side section 150, an upper section 152, and a lower section 154. The first side section 148, the second side section 150, the upper section 152, and the lower section 154 may be arranged to substantially circumscribe a hollow opening 158 of the end cap 144.

The upper section 152 of the end cap 144 may connect between the first side section 148 and the second side section 150. The lower section 54 of the end cap 144 may also connect between the first side section 148 and the second side section 150. The end cap 144 may therefore include a continuous, non-interrupted perimeter P2.

Portions of the end cap 144 may deflect in response to battery cell 32 expansion forces occurring along the cell stack axis A. The end cap 144 may therefore function as a spring member for filing the space between the cell stack 22 and the side wall 46.

The first side section 148 of the end cap 144 may include a first profile, and the second side section 150 of the end cap 144 may include a second, different profile. The first profile of the first side section 148 may be configured to match the profile of the end of the cell stack 22, and the second profile of the second side section 150 may be configured to at least partially match the profile of the draft angle α of the side wall 46. Accordingly, in the exemplary embodiment, the first side section 148 includes a flat profile or a slightly convex profile, and the second side section 150 includes a sloped or angled profile. However, other configurations are contemplated within the scope of this disclosure.

A foam structure 160 (see FIG. 10) may be positioned within the hollow opening 158 of the end cap 144. The foam structure 160 may be sprayed or inserted into the hollow opening 158 and may increase the structural integrity of the traction battery pack 18.

The first side section 148 of the end cap 144 may be configured to interface with the cell stack 22, the second side section 150 may be configured to interface with the side wall 46, the upper section 152 may be configured to interface with the upper enclosure structure 62 of the traction battery pack 18, and the lower section 154 may be configured to interface with the lower enclosure structure 64 of the traction battery pack 18.

An adhesive 66 (see FIG. 10) may be utilized to secure the end cap 144 in place relative to one or more surrounding structures of the traction battery pack 18. The adhesive 66 may be applied between the cell stack 22 and the first side section 148 of the end cap 144, between the second side section 150 of the end cap 144 and the side wall 46, between the upper section 152 of the end cap 144 and the upper enclosure structure 62, and/or between the lower section 154 of the end cap 144 and the lower enclosure structure 64. Once cured, the adhesive 66 can retain the end cap 144 in place and add stiffness across the traction battery pack 18.

FIG. 11 illustrates another exemplary end cap 244 that can be implemented for use within a traction battery pack, such as the traction battery pack 18 of FIGS. 1-3. Like the end cap designs discussed above, the end cap 244 may be positioned to fill a space between one or more of the cell stacks 22 and a side wall 46 of the enclosure assembly 24. The side wall 46 may be part of the enclosure tray 28, the enclosure cover 26, or both.

The side wall 46 of the enclosure assembly 24 may include a draft angle α and therefore may not exhibit a profile that neatly accommodates the sum of the cell stack 22. The end cap 244 may therefore establish an interface that translates or “squares” the draft angle α of the side wall 46. Once positioned between the side wall 46 and the cell stack 22, the end cap 244 may exert a compression load 99 on the cell stack 22 for counteracting battery cell 32 expansion forces, for example.

The end cap 244 may be a multi-piece structure that includes a first end cap section 270 and a second end cap section 272. The second end cap section 272 may be configured to nest together with the first end cap section 270.

The first end cap section 270 may be a unitary, single-piece structure that includes an upper flange section 274, a lower flange section 276, and a mid-section 278 that extends between the upper flange section 274 and the lower flange section 276. Similarly, the second end cap section 272 may be a unitary, single-piece structure that includes an upper flange section 280, a lower flange section 282, and a mid-section 284 that extends between the upper flange section 280 and the lower flange section 282.

The upper flange section 274 of the first end cap section 270 may interface with the upper flange section 280 of the second end cap section 272 to establish a first nesting interface 286 of the end cap 244. In an embodiment, upper flange section 274 includes a stepped profile. The upper flange section 280 may overlap the upper flange section 274 to establish the first nesting interface 286. However, other configurations are possible as would be understood by a person of ordinary skill in the art having the benefit of this disclosure.

The lower flange section 282 of the second end cap section 272 may interface with the mid-section 278 of the first end cap section 270 to establish a second nesting interface 288 of the end cap 244. In an embodiment, the lower flange section 282 abuts against a stop 290 that protrudes from the mid-section 278 to establish the second nesting interface 288. However, other configurations are possible as would be understood by a person of ordinary skill in the art having the benefit of this disclosure.

The first end cap section 270 and the second end cap section 272 may be bonded or otherwise secured together at each of the first nesting interface 286 and the second nesting interface 288. An adhesive may be utilized to secure the first and second end cap sections 270, 272 together for establishing the end cap 244, for example.

The upper flange section 274 of the first end cap section 270, the upper flange section 280 of the second end cap section 272, the mid-section 278 of the first end cap section 270, the mid-section 284 of the second end cap section 272, and the lower flange section 282 of the second end cap section 272 may be arranged to substantially circumscribe a hollow opening 258 of the end cap 244.

The mid-section 278 of the first end cap section 270 may include a first profile, and the mid-section 284 of the second end cap section 272 may include a second, different profile. The first profile of the mid-section 278 may be configured to match the profile of the end of the cell stack 22, and the second profile of the mid-section 284 may be configured to at least partially match the profile of the draft angle α of the side wall 46. Accordingly, in the exemplary embodiment, the mid-section 278 includes a substantially flat profile, and the mid-section 284 includes a sloped or angled profile. However, other configurations are contemplated within the scope of this disclosure.

A foam structure 260 may be positioned between the end cap 244 and the side wall 46. The foam structure 260 may urge the second end cap section 272 into sufficient contact with the first end cap section 270.

The mid-section 278 of the first end cap section 270 may be configured to interface with the cell stack 22, the mid-section 284 of the second end cap section 272 may be configured to interface with the side wall 46 or the foam structure 260, the upper flange sections 274, 280 may be configured to interface with the upper enclosure structure 62 of the traction battery pack 18, and the lower flange section 276 of the first end cap section 270 may be configured to interface with the lower enclosure structure 64 of the traction battery pack 18. The mid-section 278 of the first end cap section 270 may also interface with the foam structure 260.

An adhesive 66 may be utilized to secure the end cap 244 in place relative to one or more surrounding structures of the traction battery pack 18. The adhesive 66 may be applied between the end cap 244 and one or more of the cell stack 22, the side wall 46, the upper enclosure structure 62, and the lower enclosure structure 64. Once cured, the adhesive 66 can retain the end cap 244 in place and add stiffness to the traction battery pack 18

The end caps of this disclosure are capable of establishing an interface between cell stacks and enclosure structures that include walls that extend along a draft angle. The end caps provide solutions to various assembly complexities that can arise.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
an enclosure assembly;
a cell stack housed within the enclosure assembly; and
an end cap arranged to establish an interface between a side wall of the enclosure assembly and the cell stack.

2. The traction battery pack as recited in claim 1, wherein the cell stack includes a grouping of battery cells supported between a first cross-member beam and a second cross-member beam.

3. The traction battery pack as recited in claim 2, wherein the end cap is attached to a pultrusion insert of the first cross-member beam or the second cross-member beam.

4. The traction battery pack as recited in claim 1, wherein the side wall includes a draft angle, and the end cap squares the draft angle.

5. The traction battery pack as recited in claim 1, wherein the end cap includes a first side section that interfaces with the cell stack and a second side section that interfaces with the side wall.

6. The traction battery pack as recited in claim 5, comprising a foam structure arranged between the second side section and the side wall.

7. The traction battery pack as recited in claim 5, wherein the first side section is flat and the second side section is sloped or angled to match a draft angle of the side wall.

8. The traction battery pack as recited in claim 5, wherein the end cap includes an upper section that interfaces with an upper enclosure structure and a lower section that interfaces with a lower enclosure structure.

9. The traction battery pack as recited in claim 5, comprising an adhesive disposed between the first side section and the cell stack and further between the second side section and the side wall.

10. The traction battery pack as recited in claim 1, wherein the end cap includes a first side section, a second side section, an upper section, and a lower section arranged to substantially circumscribe a hollow opening of the end cap.

11. The traction battery pack as recited in claim 10, wherein a gap extends between the lower section and the second side section.

12. The traction battery pack as recited in claim 10, wherein the end cap includes a continuous, non-interrupted perimeter.

13. The traction battery pack as recited in claim 1, wherein the end cap includes a first end cap section and a second end cap section that nests together with the first end cap section.

14. The traction battery pack as recited in claim 13, wherein the first end cap section includes a first flange section and the second end cap section includes a second flange section, wherein the second flange section overlaps the first flange section to establish a nesting interface between the first end cap section and the second end cap section.

15. The traction battery pack as recited in claim 13, comprising a foam structure that urges the second end cap section into the first end cap section.

16. A traction battery pack, comprising:
an enclosure assembly including an enclosure cover and an enclosure tray;
a cell stack received within the enclosure tray and including a grouping of battery cells arranged between a first cross-member beam and a second cross-member beam; and
an end cap arranged between the cell stack and a side wall of the enclosure tray and configured to exert a compressive load against at least one of the cell stack or the side wall.

17. The traction battery pack as recited in claim 16, wherein the end cap includes a side section configured to square a draft angle of the side wall.

18. The traction battery pack as recited in claim 16, wherein the end cap is a unitary, single-piece metallic structure.

19. The traction battery pack as recited in claim 16, wherein the end cap is a multi-piece metallic assembly that includes a first end cap section and a second end cap section that is configured to nest together with the first end cap section.

20. The traction battery pack as recited in claim 16, comprising a foam structure arranged between the end cap and the side wall or arranged within a hollow opening of the end cap.
